(19) United States
(12) Patent Application Publication
(10) Pub. No.: US 2001/0054044 A1
(43) Pub. Date: Dec. 20, 2001

(54) Method for monitoring and browsing database of test system

(76) Inventors: Yi Bo Liu, Tien-Chin City (CN); Tong S. Chen, Taipei (TW); Kuang Shin Lin, Taipei (TW)

Correspondence Address: SAWYER LAW GROUP LLP, Embarcadero Corporate Center, Suite 406, 2465 East Bayshore Road, Palo Alto, CA, 94303, US

(21) Appl. No.: 09/881,821

(22) Filed: Jun. 14, 2001

(30) Foreign Application Priority Data
Jun. 14, 2000 (TW) 89111558

(51) Int. Cl. G06F 17/30; G05B 13/02

(52) U.S. Cl. 707/104.1; 700/28; 700/108; 707/9; 707/3

(57) ABSTRACT

A method for monitoring and browsing a database for a test system is proposed. In application of the internet system, a user connects a personal computer and an internet server through a network, wherein the internet server is connected a database server or acts as a database server if a database system is installed in the internet server, allowing the user to browse test results in the database server. With a proper access right for the database system, the user can remotely access and control the database system by using a browser and internet. As a result, the method for monitoring and browsing the database for the test system, by means of the browser and internet, allows the user not only to browse the test results in the database system but also to monitor and control the database system remotely.

### FIELD OF THE INVENTION

The present invention relates to methods for monitoring and browsing databases of test systems, and more particularly, to a method for monitoring and browsing a database for a test system in application of an internet system.

### BACKGROUND OF THE INVENTION

A conventional method for browsing and monitoring test results of a test system is based on the architecture of client and server, that is, a user's computer at the client needs special software to search data in the server. Moreover, the conventional method for browsing and monitoring the test results of the test system can be applied only to local area network (LAN) but not to wide area network (WAN) due to the inherent restriction on the architecture of client and server.

Therefore, test results are generally displayed on a test computer at the client where a test is performed by applying the test system. Since the test computers distribute over different factories, areas or countries, other people can not access the test results. For example, if a supervisor at the production line prefers to know the test status or test schedule of testers for a product, he or she usually gets preferred information through e-mails, however, this generates the following drawbacks.

A test report of the test results is only accessible for the tester rather than other testers or supervisors.

The supervisor can not monitor the real-time status of the test, for example, the test is being proceeded or is completed.

Information is hardly provided that if the test for a certain type of products is completed, for example, if the test for all language versions used in an operating system for the type of products is completed.

The integrated test schedule of the product is not available for the supervisor due to the unavailability of the real-time status of the test.

As concluded from the above-mentioned, in order to solve the foregoing drawbacks present in the conventional method for browsing and monitoring the database of the test system, i.e. the limited availability of test results and the inherent restriction on the architecture of client and server, a novel method for monitoring and browsing a database for a test system is proposed. This method allows a user at a personal computer to browse test results in the database system by using a browser of the personal computer. As such, the test status of each tester is available for the user, so as to integrate and obtain the overall test schedule for a product. Moreover, with a certain access right for the database system, the user can remotely access and control the database system in a database server or a web server by using the browser and internet.

### SUMMARY OF THE INVENTION

The primary objective of the present invention is to provide a method for monitoring and browsing a database for a test system, in application of an internet system without requiring special software, allowing a user to browse test results in the database system by using a browser and internet, and to remotely monitor and control the database system in a database server or an internet server according to a certain access right for the database system.

According to the foregoing objectives, a method for monitoring and browsing a database for a test system is proposed in the present invention. The test system used in invention comprises a personal computer, an internet server and a database server; if a database system is installed in the internet server, the database server of the test system is not required since the internet server may function as a database server.

During the process of monitoring and browsing the database of the test system, in application of an internet system, the user connects the personal computer and the internet server, which either acts as a database server for containing the database system therein, or is further connected with the database server of the test system. This allows the user to browse the test results in the database system through the internet server, and thus the test results can be directly browsed if the internet server contains the database system therein. The user inputs a search condition to the browser of the personal computer for search and retrieve in the database system of the database server, so as to obtain a report of the test results to be searched. With the certain access right for the database system, the user can remotely access and control the database system in the database server or internet server by using the browser and internet. If the user is a system administrator of the database system, the user can set up the right for accessing the database system and for browsing the test results in the database system, so as to remotely monitor and control the test results of the database system.

### BRIEF DESCRIPTION OF DRAWINGS

The above and other objectives, features, and advantages of the present invention will become apparent from the following description when taken in conjunction with accompanying drawings which illustrate preferred embodiments of the present invention by means of examples. The contents of the accompanying drawings are described as follows:

FIG. 1 is a block diagram illustrating the basic architecture for a test system used in a method of monitoring and browsing a database of the present invention;

FIG. 2 is a flow chart illustrating the steps involved in browsing and monitoring a database system by using a method for monitoring and browsing a database of a test system of the present invention;

FIG. 3 is a flow diagram illustrating in detail the steps involved in obtaining data for generating a test report in FIG. 2; and

FIG. 4 is a flow diagram illustrating in detail the steps involved in selecting an item for searching data related to a test in FIG. 2.

### DETAILED DESCRIPTION OF PREFERRED EMBODIMENTS

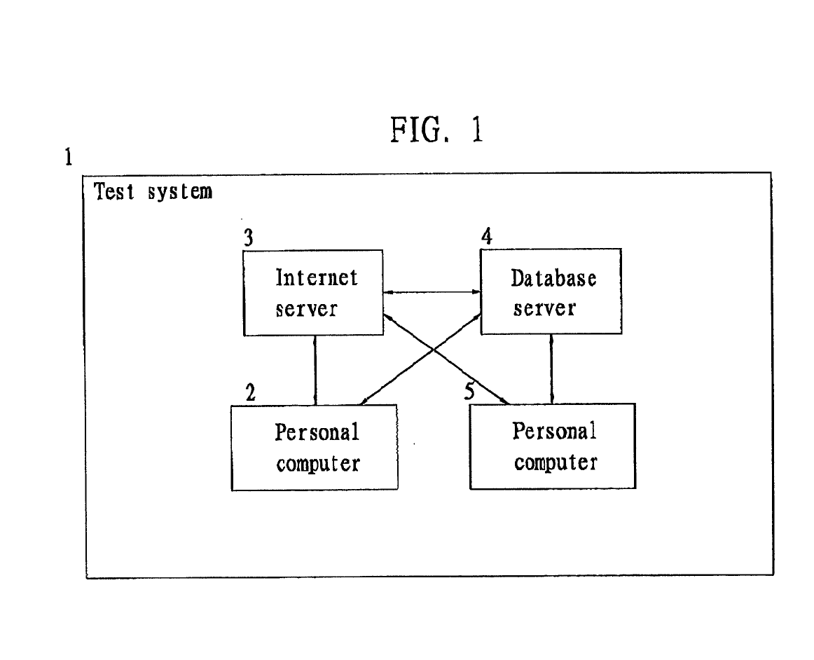

FIG. 1 is a block diagram illustrating the basic architecture for a test system used in a method of monitoring and browsing a database of the present invention. As shown in the drawing, the test system 1 consists of a personal computer 2, an internet server 3, and a database server 4. If a database system is embedded in the internet server 3, the database server 4 is not required since the internet server 3 may function as the database server 4.

A user connects the personal computer 2 and the internet server 3, which acts as the database server 4 or is further connected with the database server 4, allowing the user to browse test results in the database server 4. In the condition of the internet server 3 with the database system acting as the database server, the user directly browses the test results in the database system of the network server 3. The test results, uploaded from a personal computer 5 to the database system in the database server 4 or in the internet server 3 with the database system, are then available for other users for browsing, retrieving and searching purposes. Upon receiving the test results from the personal computer 5, the database system in the database server 4 or in the internet server 3 with the database system immediately integrates and processes the test results.

During browsing, the user inputs a search condition to a browser of the personal computer 2 for setting up a condition for generating a test report. The search condition includes information for machine type, tester, operating system, language, test tool, test status, test time, time for downloading test results, and time for uploading test results. As such, the user can search and retrieve the database system in the database server 4 or in the internet server 3 according to the search condition. Moreover, after searching and retrieving, the user at the personal computer 2 is able to send a request to the database system for browsing the test report generated by the database system. Upon receiving the request, the database system transmits the test report to the personal computer 2 through internet for displaying on the browser of the personal computer 2.

With a certain right of the user for accessing the database system, the user can remotely access and control the database system in the database server 4 or in the internet server 3 with the database system through the browser of the personal computer 2 or 5. If the user is a system administrator of the database system, the user can set up rights of users for accessing the database system and for browsing the test results in the database system, so as to remotely monitor and control the database system in the database server 4 or in the internet server 3.

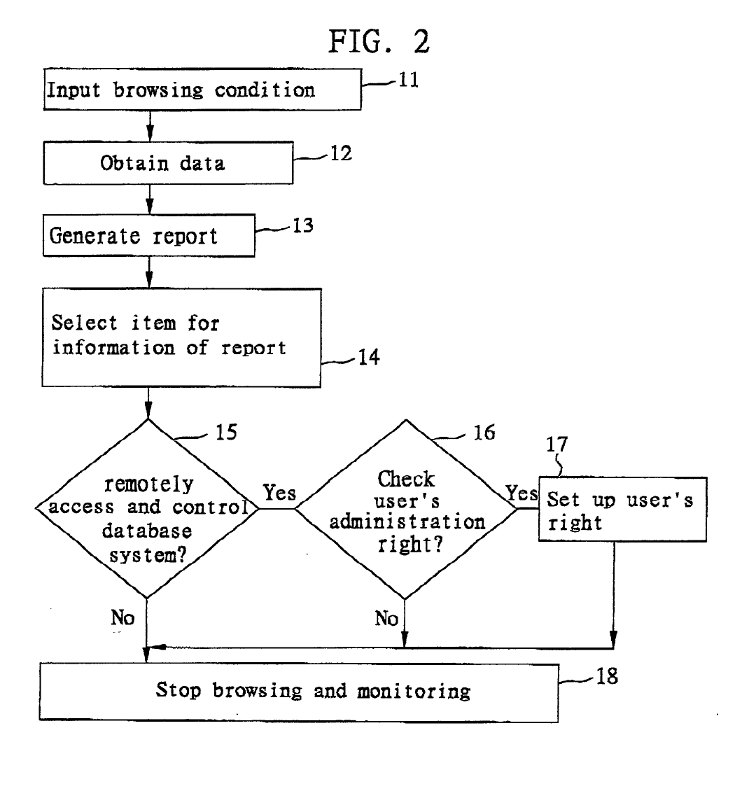

FIG. 2 is a flow chart illustrating the steps involved in browsing and monitoring a database system by using a method for monitoring and browsing a database of a test system of the present invention. In step 11, the user inputs a browsing condition to a browser of the computer 2 for setting up a condition for generating a test report. The browsing condition, used for searching and retrieving the database system in the database server 4 or in the internet server 3 with the database system, includes information for machine type, tester, operating system, language, test tool, test status, test time, time for downloading test results, and time for up-loading test results. Then it moves on to step 12.

In step 12, upon receiving the browsing condition inputted by the user, the database system in the database server 4 or in the internet server 3 searches data required for generating the test report according to the user's right for accessing the database system. Then it moves on to step 13.

In step 13, the database system in the database server 4 or in the internet server 3 transforms the searched data into a certain format for generating the test report with a test status having downloading time and uploading time. The user at the personal computer 2 can send a request to the database system for browsing the test report in the database system. Upon receiving the request, the database system transmits the test report to the personal computer 2 through internet for displaying on the browser of the personal computer 2. It then moves on to step 14.

In step 14, the user selects an item for search data related to the test report, e.g. a test record, on the browser of the personal computer 2, and send the searching request to the database system in database server 4 or the internet server 3. Upon receiving the searching request, the database system searches the data as requested and then transmits the searched data to the personal computer 2. The searched data for the selected item includes information for machine type, tester, operating system, language, test tool, test status, test time, time for downloading test results, and time for uploading test results. Then it moves on to step 15.

In step 15, the user at the personal computer 2 determines if to remotely access and control the database system in the database server 4 or the internet server 3 for setting up rights of users for accessing the database system and for browsing test results in the database system. If the user determines to set up the rights for accessing and browsing the database system, it moves on to step 16; otherwise, it moves on to step 18.

In step 16, the database system in the database server 4 or the internet server 3 checks the user's right for being a system administrator, that is, only the system administrator is allows to set up the rights of users for accessing the database system and for browsing the test results in the database system. If the user is verified as being the system administrator, it moves on to step 17; otherwise, it moves on to step 18.

In step 17, the user verified as being a system administrator set up the rights of users for accessing the database system and for browsing the test results in the database system. Then it moves on to step 18.

In step 18, monitoring and controlling the database system stops.

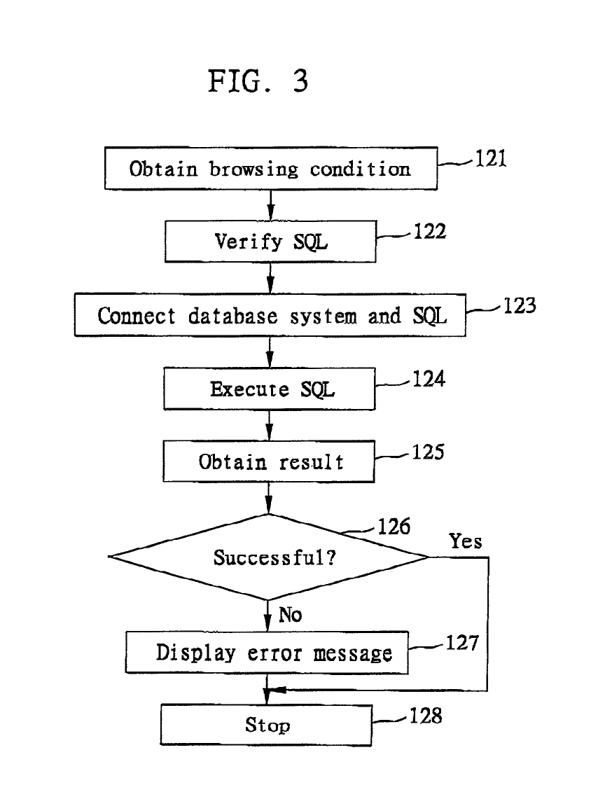

FIG. 3 is a flow diagram illustrating in detail the steps involved in obtaining data for generating a test report in FIG. 2. As shown in the drawing, in step 121, the database system in the database server 4 or the internet server 3 with the database system obtains the browsing condition inputted by the user. Then it moves on to step 122.

In step 122, the database system verifies search query language (SQL). Then it moves on to step 123.

In step 123, the connection between the database system and the SQL is established. It then moves on to step 124.

In step 124, the SQL is executed. It then moves on to step 125.

In step 125, data searched by executing the SQL is obtained. Then it moves on to step 126.

In step 126, the search is determined to be successful or not. If it is successful, it moves on to step 128; otherwise, it moves on to step 127.

In step 127, an error message is displayed if the search is not successful. Then it moves on to step 128.

In step 128, the search stops.

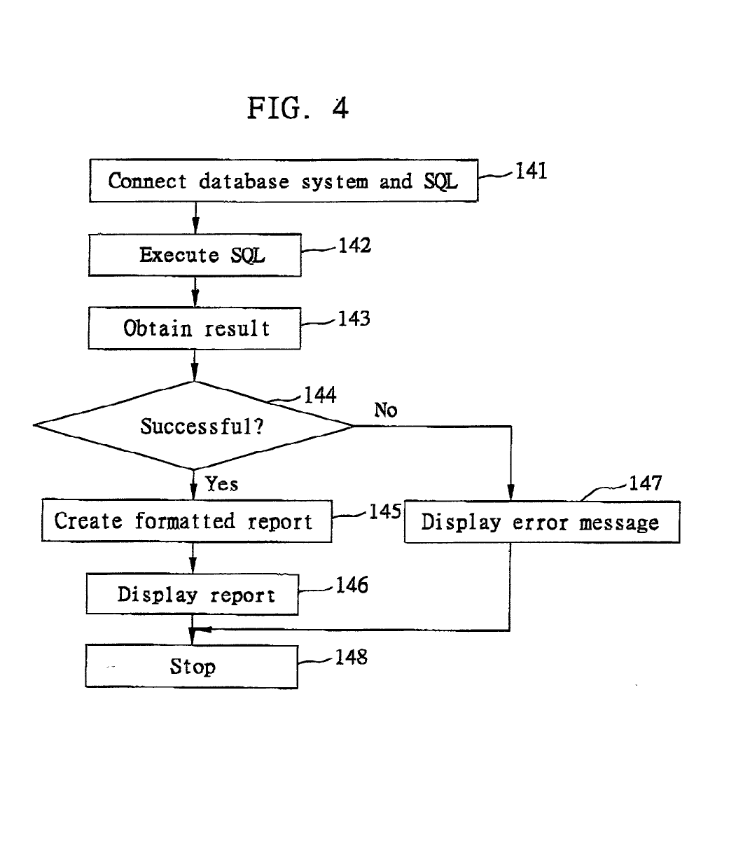

FIG. 4 is a flow diagram illustrating in detail the steps involved in selecting an item for searching data related to a test in FIG. 2. As shown in the drawing, in step 141, the connection between the database system and search query language (SQL) is established. Then it moves on to step 142.

In step 142, the SQL is executed. It then moves on to step 143.

In step 143, the searched data for the selected item is obtained by executing the SQL. Then it moves on to step 144.

In step 144, the search is determined to be successful or not. If it is successful, it moves on to step 145; otherwise, it moves on to step 147.

In step 145, a formatted report is created by the database. The report includes information for machine type, tester, operating system, language, test tool, test status, test time, time for downloading test results, and time for uploading test results. Then it moves on to step 146.

In step 146, the report is displayed on the browser of the personal computer. The report includes information for machine type, tester, operating system, language, test tool, test status, test time, time for downloading test results, and time for uploading test results. Then it moves on to step 148.

In step 147, an error message is displayed if the search is not successful. It then moves on to step 148.

In step 148, the search stops.

As concluded from the above-mentioned, the method for monitoring and browsing a database of a test system proposed in the invention, in application of an internet system without requiring special software, allows a user to browse test results in a database system in a database server or in a internet server with the database system of the test system. Moreover, the test results, uploaded from a personal computer to the database system, are available for other users through internet for browsing, retrieving and searching purposes. In addition, upon receiving the test results from the personal computer, the test results can be immediately integrated and processed by the database system.

During browsing, a search condition inputted by the user inputs to a browser of the personal computer is used for searching and retrieving the database system of the database server or in the internet server. The search condition includes information for machine type, tester, operating system, language, test tool, test status, test time, time for downloading test results, and time for uploading test results. Moreover, after searching and retrieving, the database system transmits the test report to the personal computer through internet for displaying on the personal computer according to the request of the user for browsing the test report.

With a certain right of the user for accessing the database system, the user can remotely access and control the database system in the database server or in the internet server through the browser of the personal computer. If the user is a system administrator of the database system, the user can set up rights of users for accessing the database system and for browsing the test results in the database system, so as to remotely monitor and control the database system in the database server or in the internet server.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for monitoring and browsing a database of a test system having a personal computer and a server unit with a database system, in application of an internet system, for allowing a user to browse through the server unit via a browser of the personal computer, and to remotely monitor and control the server unit according to the user's right for accessing the database system, the method comprising the steps of:
(a) inputting a browsing condition by the user to the browser of the personal computer for setting up a condition for generating a test report, and searching the database system of the server unit;
(b) obtaining data used for generating the test report from the database system of the server unit according to the browsing condition and the user's right for accessing the database system;
(c) generating the test report having the obtained data being transformed into a certain format via the database system of the server unit, and transmitting the test report, the test report further having a test status for downloading time and uploading time to the personal computer through the internet system for displaying on the browser of the personal computer;
(d) selecting an item for searching data related to the test report on the browser of the personal computer, and transmitting a request for searching the item to the database system of the server unit, after searching via the database system, transmitting data for the item to the personal computer for displaying;
(e) determining if to remotely access and control the database system of the server unit via the user at the personal computer for setting up rights of users for accessing the database system and for browsing test results in the database system; and
(f) stopping monitoring and browsing the database system.

2. The method for monitoring and browsing a database of a test system of claim 1, wherein in the determining step (e) the database system verifies the user's right for being a system administrator and takes corresponding actions.

3. The method of monitoring and browsing a database for a test system of claim 2, wherein in the condition of the user being verified as the system administrator, the user is allowed to set up the rights of users for accessing the database system and for browsing the test results in the database system.

4. The method for monitoring and browsing a database of a test system of claim 1, wherein the server unit is an internet server with a database system.

5. The method for monitoring and browsing a database of a test system of claim 1, wherein the server unit includes an internet server and a server with a database system.

6. The method for monitoring and browsing a database of a test system of claim 1, wherein the server unit includes an internet server with a database system and a server with a database system.

7. The method for monitoring and browsing a database of a test system of claim 1, wherein the condition for generating the test report includes information for machine type, tester, operating system, language, test tool, test status, test time, time for downloading test results, and time for uploading test results.

8. The method for monitoring and browsing a database of a test system of claim 1, wherein the data for the item selected on the browser of the personal computer includes information for machine type, tester, operating system, language, test tool, test status, test time, time for downloading test results, and time for uploading test results.

9. The method for monitoring and browsing a database of a test system of claim 1, wherein the obtaining step (b) comprises the steps of:
(b1) acquiring the browsing condition inputted by the user via the database server or the database system of the server unit;
(b2) verifying search query language (SQL) via the database system;
(b3) establishing connection between the database system and the SQL;
(b4) executing the SQL;
(b5) obtaining the data searched by executing the SQL;
(b6) determining if the search is successful and taking corresponding actions; and
(b7) stopping the search.

10. The method for monitoring and browsing a database of a test system of claim 9, wherein the determining (b6) step comprises displaying an error message if the search is not successful.

11. The method for monitoring and browsing a database of a test system of claim 1, wherein the selecting step (d) comprises the steps of:
(d1) establishing connection between the database system and search query language (SQL);
(d2) executing the SQL;
(d3) obtaining the searched data for the selected item;
(d4) determining if the search is successful and taking corresponding actions; and
(d5) stopping the search.

12. The method for monitoring and browsing a database for a test system of claim 11, wherein in the determining procedure (d4), if the search is successful, the database system creates a formatted report, which includes machine type, tester, operating system, language, test tool, test status, test time, time for downloading test results, and time for uploading test results.

13. The method for monitoring and browsing a database for a test system of claim 1, wherein the monitoring step (d4) comprises the steps of:
(d4i) establishing connection between the database system and search query language (SQL);
(d4ii) executing the SQL;
(d4iii) obtaining the searched data of the selected item;
(d4iv) determining if the search is successful, and moving on to step (d5) if it is successful, otherwise moving on to step (d7) if it is not successful;
(d4v) via the database system creating a formatted report, which includes information for machine type, tester, operating system, language, test tool, test status, test time, time for downloading test results, and time for up-loading test results;
(d4vi) displaying the formatted report on a browser, the formatted report including information for machine type, tester, operating system, language, test tool, test status, test time, time for downloading test results, and time for uploading test results, and moving on to step (d8);
(d4vii) displaying an error message if the search is not successful; and
(d4viii) stopping the search.

14. A method for monitoring and browsing a database of a test system, having a personal computer and a server unit with a database system, in application of an internet system, for allowing a user to browse through the server unit via a browser of the personal computer, and to remotely monitor and control the server unit according to the user's right for accessing the database system, the method comprising the steps of:
(a) inputting a browsing condition by the user to the browser of the personal computer for setting up a condition for generating a test report, and searching the database system of the server unit;
(b) obtaining data used for generating the test report from the database system of the server unit according to the browsing condition and the user's right for accessing the database system;
(c) generating the test report having the obtained data being transformed into a certain format via the database system of the server unit, and transmitting the test report further having a test status for downloading time and uploading time to the personal computer through the internet system for displaying on the browser of the personal computer;
(d) selecting an item for searching data related to the test report on the browser of the personal computer, and transmitting a request for searching the item to the database system of the server unit, after searching via the database system, transmitting data for the item to the personal computer for displaying;
(e) determining if to remotely access and control the database system of the server unit via the user at the personal computer for setting up rights of users for accessing the database system and for browsing test results in the database system; if to remotely access and control the database system for setting up the rights for accessing and browsing the database system, moving on to step (f); if not to remotely access and control the database system for setting up the rights for accessing and browsing the database system, moving on to step (h);
(f) verifying the right of the user at the personal computer for being a system administrator for setting up the rights of users for accessing the database system and for browsing the test results in the database system; if the user being verified as the system administrator, moving on to step (g); otherwise, moving on to step (h);
(g) setting up the rights of users for accessing the database system and for browsing the test results in the database system via the user being verified as the system administrator; and
(h) stopping monitoring and browsing the database system.

15. The method for monitoring and browsing a database of a test system of claim 14, wherein in the determining step (e), if to remotely accessing and controlling the database system of the server unit via the user at the personal computer for setting up the rights of users for accessing the database system and for browsing the test results in the database system, the database system verifies the user's right for being a system administrator and takes corresponding actions.

16. The method of monitoring and browsing a database for a test system of claim 15, wherein in the condition of the user being verified as the system administrator, the user is allowed to set up the rights of users for accessing the database system and for browsing the test results in the database system.

17. The method for monitoring and browsing a database of a test system of claim 14, wherein the server unit is an internet server with a database system.

18. The method for monitoring and browsing a database of a test system of claim 14, wherein the server unit includes an internet server and a server with a database system.

19. The method for monitoring and browsing a database of a test system of claim 14, wherein the server unit includes an internet server with a database system and a server with a database system.

20. The method for monitoring and browsing a database of a test system of claim 14, wherein the condition for generating the test report includes information for machine type, tester, operating system, language, test tool, test status, test time, time for downloading test results, and time for uploading test results.

21. The method for monitoring and browsing a database of a test system of claim 14, wherein the data for the item selected on the browser of the personal computer includes information for machine type, tester, operating system, language, test tool, test status, test time, time for downloading test results, and time for uploading test results.

22. The method for monitoring and browsing a database of a test system of claim 14, wherein the obtaining step (b) comprises the procedures of:
(b1) acquiring the browsing condition inputted by the user via the database server or the database system of the server unit;
(b2) verifying search query language (SQL) via the database system;
(b3) establishing connection between the database system and the SQL;
(b4) executing the SQL;
(b5) obtaining the data searched by executing the SQL;
(b6) determining if the search is successful and taking corresponding actions; and
(b7) stopping the search.

23. The method for monitoring and browsing a database of a test system of claim 22, wherein the determining step (b6) comprises displaying an error message if the search is not successful.

24. The method for monitoring and browsing a database of a test system of claim 14, wherein the selecting step (d) comprises the steps of:
(d1) establishing connection between the database system and search query language (SQL);
(d2) executing the SQL;
(d3) obtaining the searched data for the selected item;
(d4) determining if the search is successful and taking corresponding actions; and
(d5) stopping the search.

25. The method for monitoring and browsing a database for a test system of claim 24, wherein in the determining step (d4), if the search is successful, the database system creates a formatted report, which includes machine type, tester, operating system, language, test tool, test status, test time, time for downloading test results, and time for uploading test results.

26. The method for monitoring and browsing a database for a test system of claim 14, wherein the selecting step (d) comprises the steps of:
(d1) establishing connection between the database system and search query language (SQL);
(d2) executing the SQL;
(d3) obtaining the searched data of the selected item;
(d4) determining if the search is successful, and moving on to step (4-5) if it is successful, otherwise moving on to step (4-7) if it is not successful;
(d5) creating a formatted report via the database system, which includes information for machine type, tester, operating system, language, test tool, test status, test time, time for downloading test results, and time for up-loading test results;
(d6) displaying the formatted report on a browser, the formatted report including information for machine type, tester, operating system, language, test tool, test status, test time, time for downloading test results, and time for uploading test results, and moving on to step (d8);
(d7) displaying an error message if the search is not successful; and
(d8) stopping the search.
